(19) United States
(12) Patent Application Publication
(10) Pub. No.: US 2015/0286353 A1
(43) Pub. Date: Oct. 8, 2015

(54) INFORMATION COLLECTION, MANAGEMENT, SHARING AND DISTRIBUTION SYSTEM AND METHOD

(71) Applicant: Mariano Delle Donne, Greenwood Village, CO (US)

(72) Inventor: Mariano Delle Donne, Greenwood Village, CO (US)

(21) Appl. No.: 14/555,898

(22) Filed: Nov. 28, 2014

Related U.S. Application Data
(60) Provisional application No. 61/910,019, filed on Nov. 27, 2013.

(51) Int. Cl. G06F 3/0482; H04L 29/08; G06F 3/0484

(52) U.S. Cl. CPC G06F 3/0482; G06F 3/04842; H04L 67/10

(57) ABSTRACT

A system includes a first manager component, a second manager component, a user interface component and a controller component. The first manager component manages a first set of data items. The second manager component manages a second set of data items. The user interface component enables the user to provide a first provided data item to the first manager component so as to be included within the first set of data items and to enables the user to provide a second provided data item to the second manager component so as to be included within the second set of data items. The first data item has a first attribute and a second attribute, whereas the second data item has the second attribute and a third attribute. The controller component enables the user to access the first data item via the second manager component based on the second attribute.

The present application claims priority from: U.S. Provisional Application No. 61/910,019 filed Nov. 27, 2013, the entire disclosure of which is incorporated herein by reference.

### BACKGROUND

The present invention generally relates to storing, managing and distributing data within a distributed organization.

Currents systems for managing different types of data in a law enforcement agency are inefficient at best and are damaging to the operation of the law enforcement agency at worst. For example, evidence collected during a criminal investigation is typically stored somewhere, maybe a paper file—maybe an electronic file, such that authorized personnel may access such information. However, some information collected for purposes of a criminal investigation may be useful, or even needed, for other operations within the agency. If such information is not corrected earmarked, other portions of the law enforcement agency may not find, or even be aware of the information.

There have been instances of electronically managing data within a law enforcement agency. However, such conventional systems include a plurality of silos—or data repositories and management systems—, wherein each silo is responsible for a specific type of data. As such, data sharing in order to more effectively operate within the agency is almost non-existent.

What is needed is a system and method that can efficiently manage and distribute data within a distributed organization.

### BRIEF SUMMARY

The present invention is drawn to a system and method that can efficiently manage and distribute data within a distributed organization.

An aspect of the present invention, is drawn to system that includes a first manager component, a second manager component, a user interface component and a controller component. The first manager component manages a first set of data items associated with a first system feature. The second manager component manages a second set of data items associated with a second system feature and accesses the first set of data items within the first manager component. The user interface component enables the user to provide a first provided data item to the first manager component so as to be included, within the first set of data items and to enables the user to provide a second provided data item to the second manager component so as to be included within the second set of data items. The first data item has a first attribute and a second attribute, whereas the second data item has the second attribute and a third attribute. The controller component enables the user to access the first data item via the second manager component based on the second attribute.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate exemplary embodiments of the present invention and, together with the description, serve to explain the principles of the invention. In the drawings:

FIG. 1 illustrates an example communication system in accordance with aspects of the present invention;

FIG. 2 illustrates an example management system in accordance with aspects of the present invention;

FIG. 3 illustrates an example set of manager components in accordance with aspects of the present invention;

FIG. 4 illustrates an example system in accordance with aspects of the present invention;

FIG. 5 illustrates another example system in accordance with aspects of the present invention;

FIG. 6 illustrates an example system in accordance with aspects of the present invention;

FIG. 7 illustrates sharing of data between different management components in accordance with aspects of the present invention; and

FIG. 8 illustrates an exploded view of a manager component of FIG. 7.

### DETAILED DESCRIPTION

A first aspect of the present invention provides a system and method for entering, managing and sharing data. In non-limiting, example embodiments disclosed herein, a system and method in accordance with aspects of the present invention is implements to enter, manage and share data for efficient operation of a local law enforcement agency.

In accordance with aspects of the present invention, a plurality of manager components enable the storage, retrieval, sharing and management of data associated with a specific system feature. For example, one manager component may be responsible for enabling the storage, retrieval, sharing and management of data associated with a specific crime analysis, whereas another manager component may be responsible for enabling the storage, retrieval, sharing and management of data associated with operations of the agency.

Further, each manager component will have attributes associated therewith. Data items entered into a manager component will additionally have fields of attributes, such that each data item may be associated with one or more manager component. In this manner, even though a data item is stored in one manager component, which as a specific attribute, the data item may be read by anther manager component, which has another attribute, if the appropriate attribute field of the data item are filled.

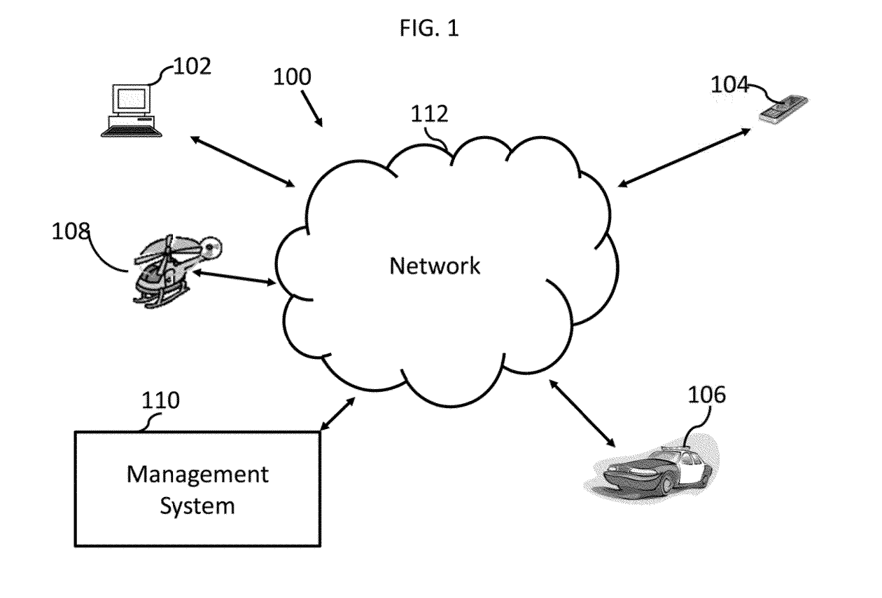

Aspects of the present invention will now be further described with reference to FIGS. 1-8.

An example embodiment includes a management system for use in a communication system.

FIG. 1 illustrates an example communication system 100 in accordance with aspects of the present invention. Communication system 100 includes a computer 102, a wireless communication device 104, a communication device in a vehicle 106, a communication device in a vehicle 108, a management system 110 and a communication network 112.

Each of computer 102, wireless communication device 104, the communication device in vehicle 106, the communication device in vehicle 108, and management system 110 are able to communicate with one another by way of network 112.

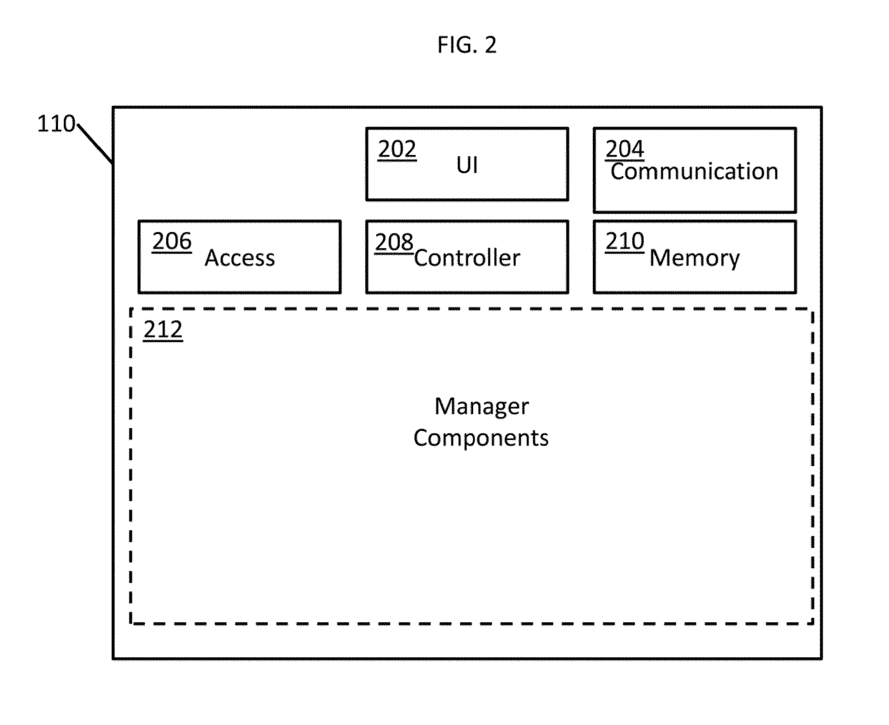

FIG. 2 illustrates an example management system 110 in accordance with aspects of the present invention. Management system 110 includes a user interface component 202, a communication component 204, an access component 206, a controller component 208, a memory component 210 and manager components 212.

In this example, user interface component 202, communication component 204, access component 206, controller component 208, memory component 210 and manager components 212 are illustrated as individual components. However, in some embodiments, at least two of user interface component 202, communication component 204, access component 206, controller component 208, memory component 210 and manager components 212 may be combined as a unitary device. Further, and some embodiments, at least one of user interface component 202, communication component 204, access component 206, controller component 208, memory component 210 and manager components 212 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Communication component 204 is operable to manage outgoing communications from management system 110 to other devices via network 112. Communications component 204 is additionally operable to manage incoming communications to management system 110 from other devices via network 112.

Controller component 208 is operable to control user interface component 202, communication component 204, access component 206, memory component 210 and manager components 212.

Memory component 210 is able to store manage and retrieve data.

Access component 206 is operable to manage access levels of users of management system 110. For example, access component 206 can manage: 1) whether a particular user can read data from memory component 210; 2) whether a particular user can write data to memory component 210; 3) whether a particular user can edit data in memory component 210; 4) whether a particular user can copy data from memory component 210; 5) whether a particular user can read a particular set of data from memory component 210; 6) whether a particular user can write a particular set of data to memory component 210; 7) whether a particular user can edit a particular set of data in memory component 210; 8) whether a particular user can copy a particular set of data from memory component 210; 9) whether a particular device can read data from memory component 210; 10) whether a particular device can write data to memory component 210; 11) whether a particular device can edit data in memory component 210; 12) whether a particular device can copy data from memory component 210; 13) whether a particular device can read a particular set of data from memory component 210; 14) whether a particular device can write a particular set of data to memory component 210; 15) whether a particular device can edit a particular set of data in memory component 210; and 16) whether a particular device can copy a particular set of data from memory component 210.

User interface component 202 enables a user to interface with management system 110. Non-limiting examples of user interface component 202 include a keyboard, a touchscreen, a mouse, an audio instruction input device and any other known user interface.

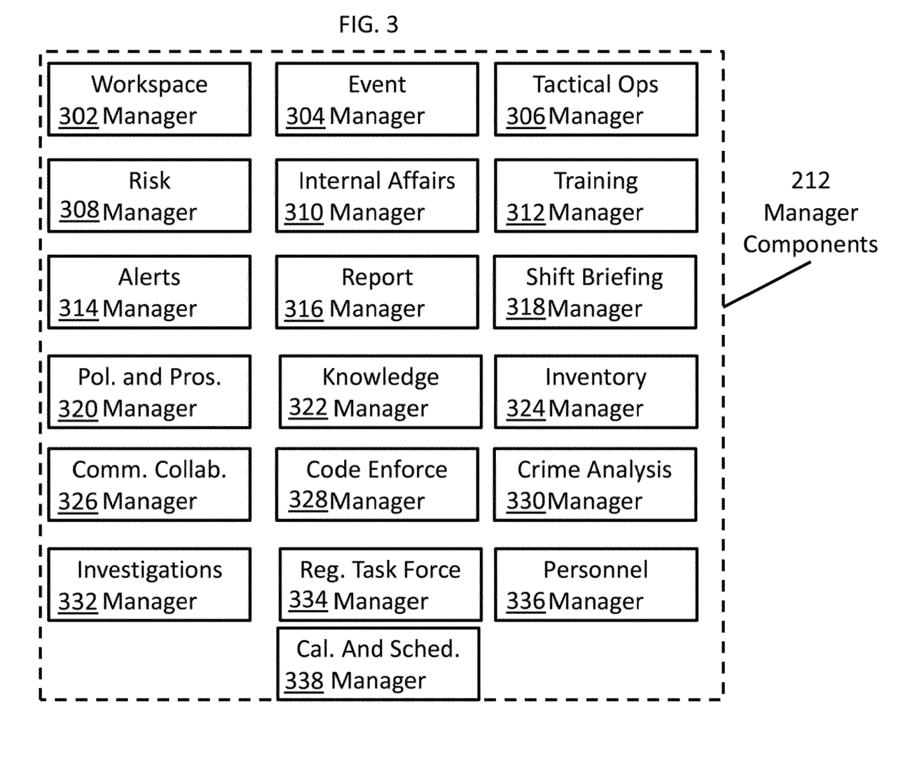

FIG. 3 illustrates an example set of manager components 212 in accordance with aspects of the present invention. In a non-limiting example embodiment in accordance with aspects of the present invention, manager components 212 include a workspace manager component 302, an event manager component 304, a tactical operations manager component 306, a risk manager component 308, an internal affairs manager component 310, a training manager component 312, an alerts manager component 314, a report manager component 316, a shift briefing manager component 318, a policies and procedure manager component 320, a knowledge manager component 322, an inventory manager component 324, a community collaboration manager component 326, a code enforcement manager component 328, a crime analysis manager component 330, an investigations manager component 332, a regional task force manager component 334, a personnel information manager component 336, and a calendar and schedule manager component 328.

In this example, workspace manager component 302, event manager component 304, tactical operations manager component 306, risk manager component 308, internal affairs manager component 310, training manager component 312, alerts manager component 314, report manager component 316, shift briefing manager component 318, policies and procedure manager component 320, knowledge manager component 322, inventory manager component 324, community collaboration manager component 326, code enforcement manager component 328, crime analysis manager component 330, investigations manager component 332, regional task force manager component 334, personnel information manager component 336, and calendar and schedule manager component 338 are illustrated as individual components. However, in some embodiments, at least two of workspace manager component 302, event manager component 304, tactical operations manager component 306, risk manager component 308, internal affairs manager component 310, training manager component 312, alerts manager component 314, report manager component 316, shift briefing manager component 318, policies and procedure manager component 320, knowledge manager component 322, inventory manager component 324, community collaboration manager component 326, code enforcement manager component 328, crime analysis manager component 330, investigations manager component 332, regional task force manager component 334, personnel information manager component 336, and calendar and schedule manager component 338 may be combined as a unitary device. Further, and some embodiments, at least one of workspace manager component 302, event manager component 304, tactical operations manager component 306, risk manager component 308, internal affairs manager component 310, training manager component 312, alerts manager component 314, report manager component 316, shift briefing manager component 318, policies and procedure manager component 320, knowledge manager component 322, inventory manager component 324, community collaboration manager component 326, code enforcement manager component 328, crime analysis manager component 330, investigations manager component 332, regional task force manager component 334, personnel information manager component 336, and calendar and schedule manager component 338 may be implemented as a computer having tangible computer-readable media for carrying or having computer-executable instructions or data structures stored thereon.

Workspace manager component 302 is operable to manage workspaces for one or a plurality of users. For example, workspace management component 302 may create maintain and delete a workspace such that data input into, edited or deleted from the workspace may be viewed, used and shared with others having been granted access to the workspace. In an example embodiment, such access may be managed by access component 206.

Event manager component 304 is operable to manage events. An event may include a criminal incident and a noncriminal incident. Event manager component 304 may manage and events regionally. In an example embodiment a collaborative workspace may be available securely from any HTML and Internet enabled mobile device to various 911/dispatch centers, various law enforcement and public safety officials responding to the event and other individuals needed in the operations. Event manager component 304 may manage involved parties and officers on the scene. Event manager component 304 enables sharing and searching of information (non-limiting examples of which include, audio, video, documents, maps and discussions) between officers at the scene. Event manager component 304 enables sharing and searching of information (non-limiting examples of which include audio, video, documents, maps and discussions) between dispatch centers. Event manager component 304 enables sharing and searching of information (non-limiting examples of which include audio, video, documents, maps and discussions) between tactical operations. Event manager component 304 enables generation of a secure area showing the most important information as approved by supervisor in charge of the operation.

Tactical operations manager component 306 is operable to manage aspects of tactical operations. Tactical operations manager component 306 may include a planning component operable to generate, store, and edit capture strategy and policies. Tactical operations manager component 306 is operable to track inventory of equipment and personnel associated with tactical operations. Tactical operations manager component 306 is operable to set up command posts. Tactical operations manager component 306 is operable to generate, store and edit information (non-limiting examples of which include audio, video, documents, maps and discussions) about locations and structures, near real time, during an incident. Tactical operations manager component 306 is operable to manage data associated with involved parties, data associated with involved tactical personnel, and data associated with incidents. Tactical operations manager component 306 is operable to generate, store and edit after action reports and final reports. Tactical operations manager component 306 is operable to manage staging areas with workflow to push data to an approved area.

Risk manager component 308 is operable to manage risk. Risk manager component 308 is operable to analyze data associated with an event and to provide a probability risk factor to one or more officers based on the provided data. Risk manager component 308 is operable to determine at risks officers activity based on use of force, complaints and commendations, acknowledgment of policies and procedures, information sharing within the department and up-to-date training credentials.

Internal affairs manager component 310 is operable to manage internal affairs within an entity associated with a management system 110. For purposes of discussion, in an example embodiment, let management system 110 be associated with a local police department wherein internal affairs manager component 310 is operable to manage internal affairs of the local police department. Internal affairs manager component 310 is operable to provide secure internal officer investigation management, manage disciplinary records, track the take your accidents, track officer accidents, track use of force (response to resistance), track vehicular pursuits, track officer complaints and commendations, track department complaints and commendations, manage medical leave and manage workers compensation. Internal affairs manager component 310 is operable to perform evaluations, manage promotions, and hiring employees.

Training manager component 312 is operable to manage training. For example, training manager component 312 is operable to enable entry and editing of policies and procedures associated with training personnel of an entity associated with management system 110. Training management component 312 may additionally be operable to schedule and track the amount of training received by each personnel within an entity associated with management system 110. Training management component 312 is operable to provide online training requests, self-help videos and documents, track training, provide training reminders (expiring certificates, upcoming classes, etc.), provide cross agency access and host LMS classes.

Alerts manager component 314 is operable to manage and share data between all the manager components. For example, alerts manager component 314 is operable to generate, distribute, and monitor alerts for users of management system 110. In one non-limiting example embodiment, one a piece of entered data, for example a description of a suspect may he entered into the system via event manager component 314. However, alerts manager component 314 may additionally provide this piece of entered data to the community collaborations manager component 326 to be shared with others in the community and to the investigations manager component 332 for officers associated with related investigations.

Shift briefing manager component 318 is operable to manage and share data with other manager components to conduct a shift briefing and review critical shift past—on information for officer safety and awareness.

Policies and procedure manager component 320 is operable to manage and share policies and procedures, receive sign-off and acknowledgment from department members on its use.

Knowledge manager component 322 is operable to manage corporate knowledge, records and documentation.

Inventory manager component 324 is operable to manage inventory for any and/or all other manager components.

Community collaboration manager component 326 is operable to manage secure communications with other entities and/or networks. For example, networks in communication with a local community (homeowner associations, schools, hospitals, etc.) and private sector businesses, non-limiting examples of which include hotels, processing plants, etc, community collaboration manager component 326 is operable to enable three-way information exchange between members of like communities (schools communicating with schools about incidents) but also with the law enforcement crime analysts and investigators.

Code enforcement manager component 328 is operable to manage rules and regulations a syndicated with federal, state, local governments and private entities. For example, code enforcement manager component 328 is operable to enable a law-enforcement officer to quickly locate property managers for apartment complexes during an operation. In another non-limiting example, code enforcement manager component 328 is operable to enable tactical teams to review property management information that is important for critical incidents, where the tactical teams need to be to address an incident.

Crime analysis manager component 330 is operable to manage information regarding crime trends, spots and incidents and control communication to various departments within a public safety agency.

Investigations manager component 332 is operable to manage cases for investigations as well as manage secure tips and leads from informants and the public.

Regional task force manager component 334 is operable to manage data and communications between entities of different groups performing functions for a common incident. In a non-limiting example, regional task force manager component 334 may include a drug task force, financial crimes task force, auto theft task force and gang task force sub-components. Regional task force manager component 334 is operable to securely share information and manage risers and their respective security rights from various law enforcement partners. For example, a drug task force may include local law enforcement agencies and federal law enforcement agencies as one collaborative workspace.

Personnel information manager component 336 is operable to manage and maintain personnel information, non-limiting examples of which include contact information, name, last name, date of birth, rank, tide, specialty, special skills (e.g., foreign language abilities), Social Security number, address, emergency contact information, etc.

Calendar and schedule manager component 338 is operable to manage calendars and scheduling, such as shifts training schedules, etc.

An aspect of the present invention is drawn to gathering of law enforcement information, for example via electronic forms, and accumulating that information for reporting and analysis. Conventional paradigms for law enforcement include a distributed collection of information by way of a combination of electronic and written documentation that is not easily shared between users.

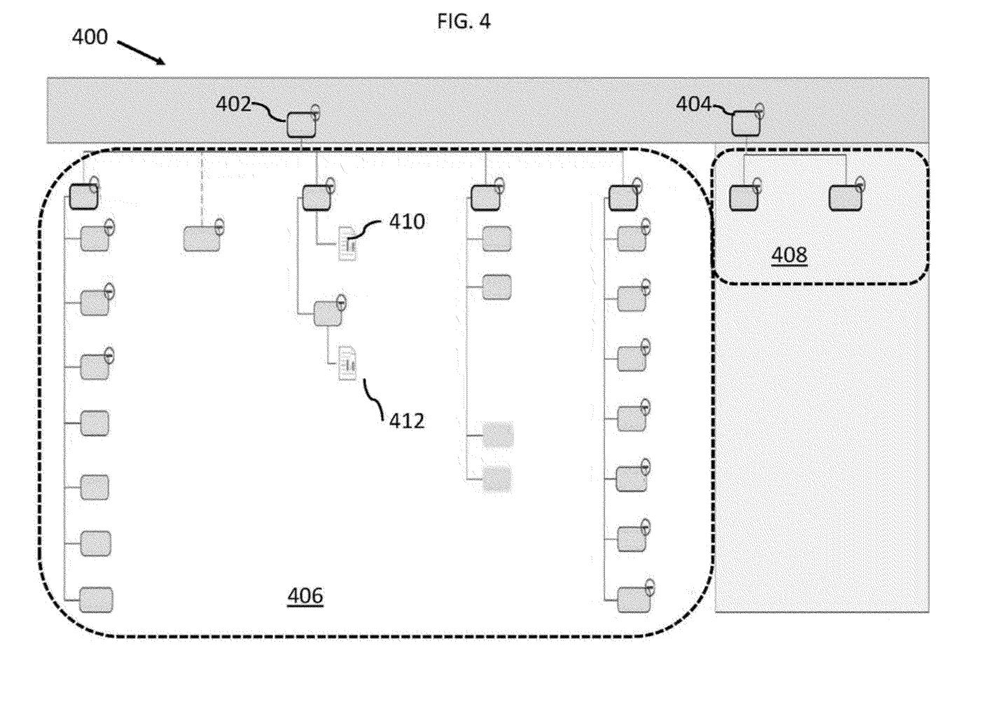

FIG. 4 illustrates an example system 400 in accordance with aspects of the present invention. As shown in the figure, system 400 includes a server 402 and a server 404. Server 402 includes a plurality of manager components 406, whereas server 404 includes a plurality of manager components 408. Each of the manager components may have data structures stored therein, examples of which are indicated by data structure 410 and data structure 412.

As shown in example system 400, different manager components may reside in different systems. For example, plurality of manager components 406 are located within server 402, whereas plurality of manager components 408 are located within server 404. In this example, server 402 is generally associated with public safety, whereas server 404 is generally associated with a server to which public entities are granted secure access. This figure additionally represents security associated with different manager components, wherein different people may be assigned different levels of access for each respective component. For example a level access may be granted to read, edit, enter, and/or copy data within a particular manager component.

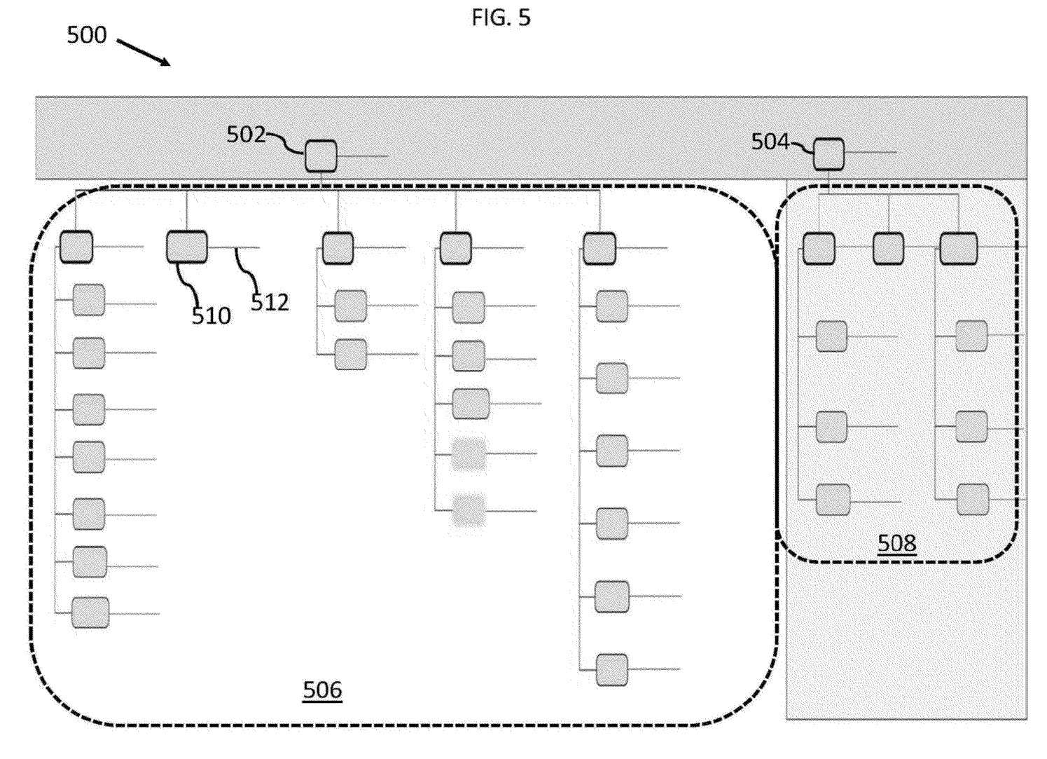

FIG. 5 illustrates an example system 500 in accordance with aspects of the present invention. As shown in the figure, system 500 includes, a server 502 and a server 504. Server 502 includes a plurality of manager components 506, whereas server 504 includes a plurality of manager components 508.

As shown in example system 500, different manager components may reside in different systems. For example, plurality of manager components 506 are located within server 502, whereas plurality of manager components 508 are located within server 504. FIG. 5 illustrates a component naming capability in accordance with aspects of the present invention. For example, a system having manager components in accordance with the present invention may be deployed wherein a user may have the ability to rename one or a plurality of the manager components.

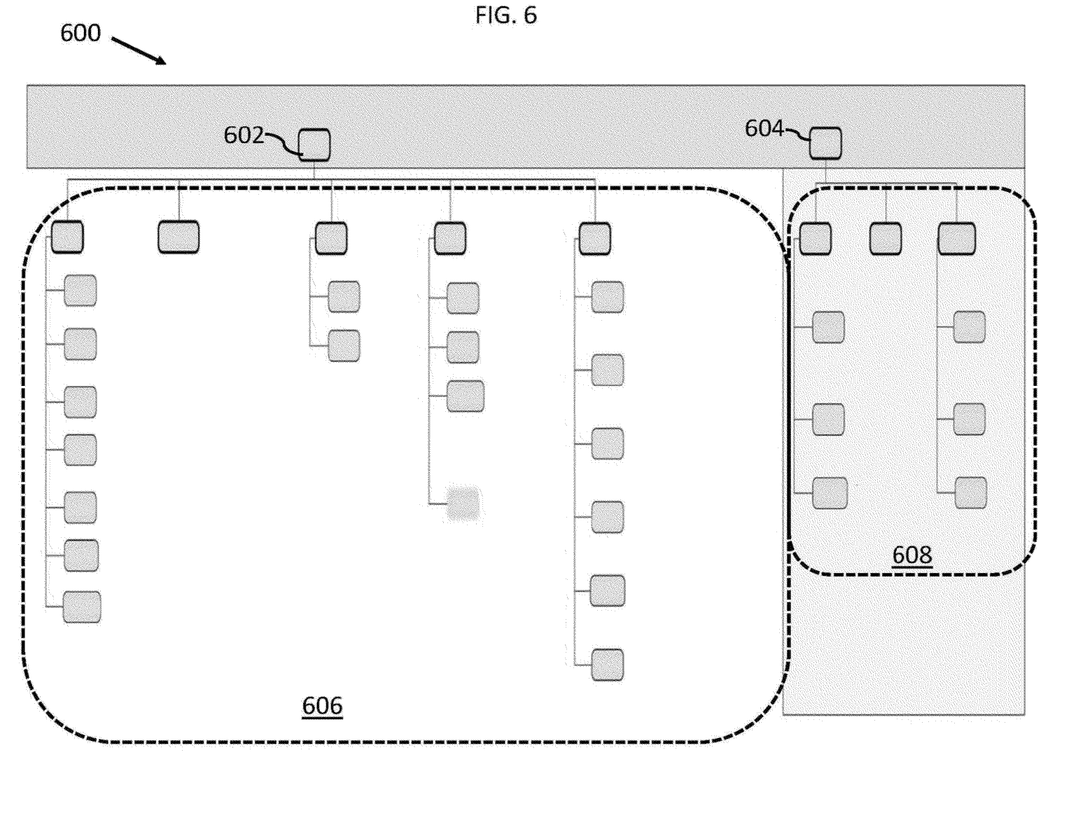

In some embodiments, the different manager components may be accessed using unique uniform resource locators (URLs). This will be described in greater detail with reference to FIG. 6.

FIG. 6 illustrates an example system 600 in accordance with aspects of the present invention. As shown in the figure, system 600 includes a server 602 and a server 604. Server 602. includes a plurality of manager components 606, whereas server 604 includes a plurality of manager components 608.

As shown in example system 600, different manager components may reside in different systems. For example, plurality a manager components 606 are located within server 602, whereas plurality of manager components 608 are located within server 604. FIG. 6 illustrates how the management components may be constructed by way of universal resource locators, such that each management component may have its own associated webpage/website in accordance with aspects of the present invention.

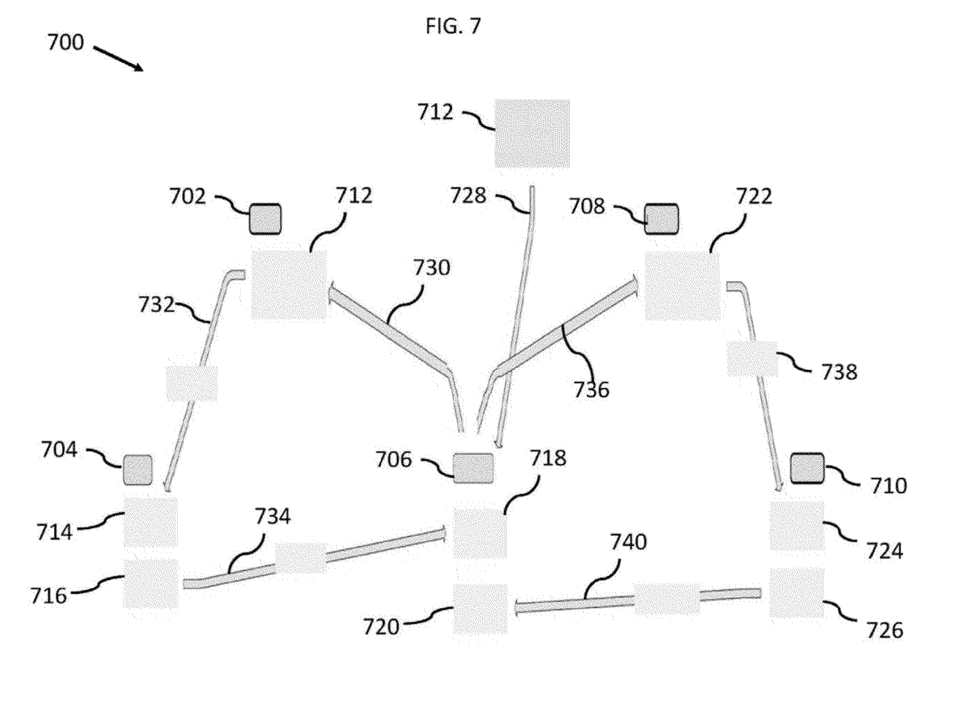

FIG. 7 illustrates sharing of data between different management components in accordance with aspects of the present invention. FIG. 7 includes manager component 702, manager component 704, manager component 706, manager component 708, manager component 710 and a data source 712. Manager component 702 includes a data item 712 stored therein. Manager component 704 includes a data item 714 and a data item 716 stored therein. Manager component 706 includes a data item 718 and a data item 720 stored therein. Manager component 708 includes a data item 722 stored therein. Manager component 710 includes a data item 724 and a data item 726 stored therein.

In some embodiments, manager component 702, manager component 704, manager component 706, manager component 708, manager component 710 and a data source 712 may physically reside separate servers that are in communication with one another over a network. In other embodiments, at least two of manager component 702, manager component 704, manager component 706, manager component 708, manager component 710 and a data source 712 may physically reside on a single server, yet they are all still in communication with one another.

Each manager component may have data entered via a user interface (not shown) or via an external data source. For example, data source 712 is arranged to provide manager component 706 with data as shown by arrow 728.

Further, each manager component may read data items for other manager components, as shown by the arrows between data items and manager components. For example data item 712 within manager component 702, which is additionally associated with manager component 706, may be read by manager component 706 as indicated by arrow 730.

To further discuss the aspect, for purposes of discussion let manager component 702 be an operations manager component that manages all operations of a police department and let manager component 706 be a crime analysis manager component that manages all criminal investigations. Further, let data item 712 be a bulletins and alerts data item listing bulletins and alerts for the current day. In this example embodiment, all alerts may have previously been determined to be associated with at the criminal investigations. As opposed to additionally entering, or storing data item 712 additionally in manager component 706, manager component 706 will be able to read data item 712 within manager component 702.

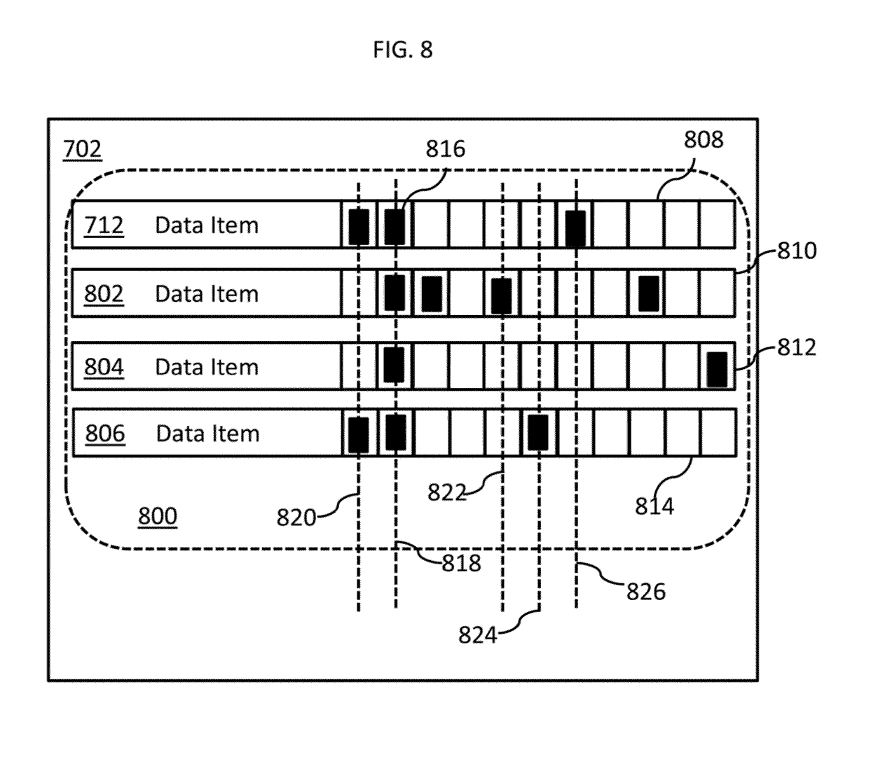

With this structural arrangement, data items need only be stored in one manager component, even though they may be useful to other manager components. The association of data items to manager components will now be further described with reference to FIG. 8.

FIG. 8 illustrates an exploded view of manager component 702. As shown in the figure, manager component 702 includes a memory component having data item 712, data item 802, data item 804, data item 806, attribute fields 808, attribute fields 810, attribute fields 812 and attribute fields 814. Other functional components of manager component 702, non-limiting examples of which include a communication component, a user interface component, etc., are not shown for purposes of brevity.

In this example, data item 712, data item 802, data item 804 and data item 806 have each been entered into manager component 702 by any known method, non-limiting examples of which include via a user interface, a keyboard, a scanner, an eternal memory, etc.

Attribute fields 808 list possible attributes of data item 712. In this example there are three attributes of data item 712 indicated by the filled attribute fields in attribute fields 808, an example of which is labeled filled attribute field 816. Similarly, attribute fields 810 list possible attributes of data item 802, whereas attribute fields 812 list possible attributes of data item 804 and attribute fields 814 list possible attributes of data item 806.

Specific attributes are associated with specific manager components. For example, and for purposes of discussion, let the attributes along dotted line 820 be associated with manager component 706, let the attributes along dotted line 818 be associated with manager component 702, let the attributes alone dotted line 822 be associated with manager component 704, let the attributes along dotted line 824 be associated with manager component 708 and let the attributes along, dotted line 826 be associated with manager component 710.

In some embodiments, a user may identify each attribute associated with a particular data item, by any known method, non-limiting examples of which include is a user interface, a keyboard, etc. In some embodiments, some attributes may be automatically assigned to a particular type of data. For example, any data involving personnel schedules may automatically be associated with a roll call manager component.

By identifying attributes for each data item, manager component 706 will be able to read data item 712 and data item 806 from manager component 702. Further, it is clear that all of data items 712, 802 804 and 806 have an attribute associated with manager component 702. This is because they were entered and stored in manager component 702 because they were determined to be primarily associated with manager component 702.

In operation, returning to FIG. 7, suppose that a user of manager component 706 is reviewing data on a specific criminal investigation. Again, for purposes of discussion, let manager component 706 be a crime analysis manager component that manages all criminal investigations. When reviewing the collected data manager component 706 may read data that was entered into other manager components that are associated with attributes of manager component 706. For example, manager component 706 may query manager component 702, as shown by arrow 730.

Returning to FIG. 8, as manager component 702 includes data item 712 and data item 806, which have attributes associated with manager component 706. Therefore, manager component 702 allows manager component 806 to read data item 712 and data item 806.

It should be noted that, as shown in FIG. 2, access component 206 will be involved at many stages of data entry and data retrieval, with respect to permitting access to specific users and permitting access to specific data.

As for entering a data item, any known data entry system or method may be used. However, attributes are associated with each data item that is to be able to be read by other manager components. This attribute association may be entered manually, or may be automated based on recognized features within the data item.

Conventionally, data and operations within a police department is stored, managed, distributed and accessed in many different, disjointed systems and methods. As such, data sharing is not efficient.

In accordance with the present invention, a system enables efficient data sharing for a police department.

Therefore a user may manage, by way of a manager component, a first set of data items associated with a first system feature, e.g, crime analysis. Further the user may manage, by way of another manager component, a second set of data items associated with a second system feature, e.g, operations. Still further, the user may access the first set of data items within said first manager component, e.g., the crime analysis manager component, by way of the other manager component, e.g., the operations manager component.

A user interface component enables the user to eater a new data item into a manager component, so as to be included with the data items already stored within the manager component. In some embodiments, the user interface will additionally enable the user to enter a new data item to another second manager component, so as to be included with the data items already stored within that manager component. In some embodiments, each manager component may have its own user interface, e.g., in situations where each manager component is a distinct device.

With the present invention, one manager component may have a specific attribute associated therewith. However, a data item stored in the manager component may have multiple attributes associated therewith, such that the data item may be read by multiple other manager components.

In some embodiments, a controller component enable the user to access the data items from one manager component to another manager component.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A data management system comprising:
a first manager component operable to manage a first set of data items associated with a first system feature;
a second manager component operable to manage a second set of data items associated with a second system feature and to access the first set of data items within said first manager component;
a user interface component operable to enable the user to provide a first provided data item to said first manager component so as to be included within the first set of data items and to enable the user to provide a second provided data item to said second manager component so as to be included within the second set of data items, the first data item having a first attribute and a second attribute, the second data item having the second attribute and a third attribute; and
a controller component operable to enable the user to access the first data item via the second manager component based on the second attribute.

2. The data management system of claim 1, further comprising an access component operable to assign, to the user, a level of access selected from the group consisting of reading access, writing access, copying access and combinations thereof.

3. The data management system of claim 2, wherein said access component is additionally operable to assign, to the user, a level of access selected from the group consisting of access to said first manager component, access to said second manager component and combinations thereof.

4. The data management system of claim 3, further comprising:
a graphical user interface operable to generate a graphical display of displayed data items for the user,
wherein said first manager component is further operable provide a portion of the first set of data items to said graphical, user interface,
wherein said second manager component is further operable provide a portion of the second set of data items to said graphical user interface, and
wherein said graphical user interface is operable to generate the graphical display as a first graphical display based on the portion of the first set of data items and to generate the graphical display as a second graphical display based on the portion of the second set of data items.

5. The data management system of claim 4, wherein said controller component is operable to enable the user to access the first data item via a pointer, within the second manager component, pointing to a location of the first data item within the first manager component.

6. The data management system of claim 1, further comprising an access component operable to assign, to the user, a level of access selected from the group consisting of access to said first manager component, access to said second manager component and combinations thereof.

7. The data management system of claim 6, further comprising:
a graphical user interface operable to generate a graphical display of displayed data items for the user,
wherein said first manager component is further operable provide a portion of the first set of data items to said graphical user interface,
wherein said second manager component is further operable provide a portion of the second set of data items to said graphical user interface, and
wherein said graphical user interface is operable to generate the graphical display as a first graphical display based on the portion of the first set of data items and to generate the graphical display as a second graphical display based on the portion of the second set of data. items.

8. The data management system of claim 7, wherein said controller component is operable to enable the user to access the first data item via a pointer, within the second manager component, pointing to a location of the first data item within the first manager component.

9. The data management system of claim 1, further comprising:
a graphical user interface operable to generate a graphical display of displayed data items for the user,
wherein said first manager component is further operable provide, a portion of the first set of data items to said graphical user interface,
wherein said second manager component is further operable provide a portion of the second set of data items to said graphical user interface, and
wherein said graphical user interface, is operable to generate the graphical display as a first graphical display based on the portion of the first set of data items and to generate the graphical display as a second graphical display based on the portion of the second set of data items.

10. The data management system of claim 9, wherein said controller component is operable to enable the user to access the first data item via a pointer, within the second manager component, pointing to a location of the first data item within the first manager component.

11. A data management method comprising:
managing, via a first manager component, a first set of data items associated with a first system feature;
managing via a second manager component, a second set of data items associated with a second system feature;
accessing, via the second manager component, the first set of data items within the first manager component;
providing, via a user interface component, a first provided data item to the first manager component so as to be included within the first set of data items,
providing, via the user interface component, a second provided data item to the second manager component so as to be included within the second set of data items, the first data item having a first attribute and a second attribute, the second data item having the second attribute and a third attribute; and
accessing, via a controller component, the first data item via the second manager component based on the second attribute.

12. The data management method of claim 11, further comprising assigning, via an access component, a level of access selected from the group consisting of reading access, writing access, copying access and combinations thereof.

13. The data management method of claim 12, wherein said assigning further comprises assigning a level of access further selected from the group consisting of access to the first manager component, access to the second manager component and combinations thereof.

14. The data management method of claim 13, further comprising:
generating, via a graphical user interface, a graphical display of displayed data items for a user;
providing, via the first manager component, a portion of the fast set of data items to the graphical user interface;
providing, via the second manager component, a portion of the second set of data items to the graphical user interface;
generating, via the graphical user interface, the graphical display as a first graphical display based on the portion of the first set of data items; and
generating, via the graphical user interface, the graphical display as a second graphical display based on the portion of the second set of data items.

15. The data management method of claim 14, wherein said accessing, via a controller component, the first data item via the second manager component based on the second attribute comprises accessing the first data item via a pointer, within the second manager component, pointing to a location of the first data item within the first manager component.

16. The data management method of claim 11, wherein said assigning further comprises assigning a level of access further selected from the group consisting of access to the first manager component, access to the second manager component and combinations thereof.

17. The data management method of claim 16, further comprising:
generating, via a graphical user interface, a graphical display of displayed data items for a user;
providing, via the first manager component, a portion of the first set of data items to the graphical user interface;
providing, via the second manager component, a portion of the second set of data items to the graphical user interface;
generating, via the graphical user interface, the graphical display as a first graphical display based on the portion of the first set of data items; and
generating, via the graphical user interface, the graphical display as a second graphical display based on the portion of the second set of data items.

18. The data management method of claim 17, wherein said controller component is operable to enable the user to access the first data item via a pointer, within the second manager component, pointing to a location of the first data item within the first manager component.

19. The data management method of claim 11, further comprising:
a graphical user interface operable to generate a graphical display of displayed data items for the user,
wherein said first manager component is further operable provide a portion of the first set of data items to said graphical user interface,
wherein said second manager component is further operable provide a portion of the second set of data items to said graphical user interface, and
wherein said graphical user interface is operable to generate the graphical display as a first graphical display based on the portion of the first set of data items and to generate the graphical display as a second graphical display based on the portion of the second set of data items.

20. The data management method of claim 19, wherein said accessing, via a controller component, the first data item via the second manager component based on the second attribute comprises accessing the first data item via a pointer, within the second manager component, pointing to a location of the first data item within the first manager component.
